(19) United States
(12) Patent Application Publication
(10) Pub. No.: US 2013/0233234 A1
(43) Pub. Date: Sep. 12, 2013

(54) COLLAPSIBLE KAYAK APPARATUS AND METHOD

(71) Applicant: Michael A. Crumpton, Miami Beach, FL (US)

(72) Inventor: Michael A. Crumpton, Miami Beach, FL (US)

(21) Appl. No.: 13/414,830

(22) Filed: Mar. 8, 2012

(51) Int. Cl. B63B 7/00; B32B 37/18; B63B 35/71

(52) U.S. Cl. 114/347; 156/227

(57) ABSTRACT

An apparatus and method of use of a foldable watercraft and method of construction. The device comprises a collapsible boat hull constructed from a lightweight, low maintenance, and inexpensive material. The boat hull is frameless, folded and unfolded quickly, and is easy to transport and store.

### FIELD OF THE INVENTION

The present invention relates to the field of boating and, more particularly, to a lightweight and portable foldable and collapsible kayak and related methods.

### BACKGROUND OF THE INVENTION

Boat ownership, and in particular, kayak ownership and use is a popular recreational pastime, but there are many barriers to entry for an average individual to enjoy the benefits of kayak ownership and use. Kayaks are typically relatively expensive to purchase, the cost for maintenance is also often high, and kayaks are generally rather large, so there are difficulties inherent in both the storage and transportation of such vessels.

Several styles of kayaks are known that address some of these problems. Composite materials and polymer-based kayaks are less difficult and costly to maintain than traditional wood vessels. They are also cheaper to produce. The problems of storage and transport, however, still remain as these kayaks are large, bulky, and relatively heavy, often necessitating multiple individuals to situate a boat into the water or onto and off of transport means.

Some modern canoes and kayaks are relatively affordable and easy to maintain, and even light enough for a single person to manipulate in and out of the water. The problem of bulk still remains so transportation and storage are still significant hurdles. A vehicle equipped with a roof rack overcomes the transportation issue, and a garage is a solution to the storage problem, but the fact remains that not all individuals possess a vehicle with a roof rack and/or a garage in which storage is possible.

Collapsible kayaks are known in the art, typically utilizing modern materials such as aluminum and plastic for construction, resulting in high performance vessels capable of collapsing into a relatively small package. These folding kayaks are generally complex in design and relatively slow (15-50 minutes) to assemble and disassemble, for such vessels require numerous parts and connectors. They are also relatively heavy (roughly 25-75 lbs) and bulky due to components such as frames, skins, and tubing. The user must clean, dry, and maintain such vessels thoroughly prior to storage so to avoid corrosion, mold, and mildew. Finally, because of the complexity and number of manufactured parts these folding kayaks are relatively expensive.

Inflatable kayaks also overcome a number of the disadvantages associated with hard-sided kayaks. These vessels are simple to assemble, sometimes required a single step comprising inflating the hull. They also are relatively compact to store and transport. However, due to the large volume of air needed for inflation, a pump to inflate and deflate the tubes is required. Inflation time can be upwards of 25 minutes, and is also physically challenging in the absence of an automatic air pump. There are a number of disadvantages to inflatable kayaks as well: These vessels are heavy, often weighing over 35 pounds; Require a pump for practical use; hull shapes are generally not conducive to efficient paddling; such vessels are susceptible to puncturing; and due to the complex manufacturing processes and materials needed to craft a seaworthy vessel, are relatively expensive.

Some companies that produce foldable kayaks include Feathercraft™, Folbot™, and Pakboats™. The Feathercraft kayaks (www.feathercraft.com) take upwards of 30 minutes to assemble weight at least 30 lbs, and cost between $2,900 CAD and $7,200 CAD. The Folbot™ kayaks (www.folbot.com) range from 24 lbs to over 60 lbs, and cost at least $1,295. Additionally, Feathercraft™ and Folbot™ kayaks each comprise dozens of individual pieces. The Pakboats™ Kayak (www.pakboats.com) costs roughly $900 and requires inflation. These kayaks are relatively expensive, assembly is time consuming, and there are many parts, which add to the general complexity of these vessels.

Accordingly, there is a need for a foldable kayak that is lightweight, portable, relatively resistant to punctures, resistant to corrosion and degradation, simple to maintain, quickly and simply assembled, contains very few parts, while being economical.

The present invention addresses these issues using a combination of folding construction, folding technique, and materials to create a watercraft that meets all these specifications.

These and other objects of the present invention are attained by a foldable and collapsible boat hull that is simple and quick to collapse and uncollapse, that is constructed from lightweight and degradation resistant materials, that collapses into an extremely small form factor, yet provides consumers with a low cost, virtually maintenance free kayak.

One object of the present invention is to provide a foldable and collapsible kayak made of a sturdy, lightweight, water resistant material.

Another object of the present invention is to provide a foldable and collapsible kayak with predetermined creases providing the user with a guide to easily unfold the boat into the proper form for usage, or to fold it for storage or transport.

Another object of the present invention is to provide a foldable and collapsible kayak that is not susceptible to damage from corrosive and degradative elements, which decrease the amount of required maintenance.

Another object of the invention is to provide a foldable and collapsible kayak that is suited for recreational purposes due to the kayak's lightweight and compact design, yet is also suited for use as an emergency rescue vessel that can be stored on small watercraft or used by rescue personnel.

Another object of the invention is to provide a foldable and collapsible kayak that, due to its simple design and construction, is inexpensively produced and inexpensive to purchase.

These and other objects, features, and advantages of the present invention will become more readily apparent from the attached drawings and the detailed description of the preferred embodiments, which follow.

### SUMMARY OF THE INVENTION

In view of the foregoing background, it is therefore an object of the present invention to provide a foldable kayak comprising a foldable multichine hull comprising a cockpit, a forward deck, an aft deck, a port hull side, and a starboard hull side. The port hull side and the starboard hull side meet to define a keel. The port hull side meets the forward and aft decks defining a port side gunwale, and the starboard hull side meets the forward and aft decks to define a starboard side gunwale. In one embodiment, a foldable insert of a size and dimension to fit inside the cockpit comprising a floor thwart, seat, seat back, and aft bulkhead is utilized in the kayak design. In one embodiment, the cockpit comprises a cockpit coaming.

In one embodiment, the kayak further comprises a first V-shaped center crease on the port hull side having a first bisecting crease beginning at the apex of the first V-shaped center crease and ending at the port side gunwale. Additionally, a second V-shaped center crease on the starboard hull side having a second bisecting crease begins at the apex of the second V-shaped center crease and ends at the starboard side gunwale.

A plurality of fasteners on the exterior side of the port hull side accommodate a first strap, wherein the first strap pulls the first V-shaped center crease closed upon itself. This pinches the port hull side on itself to create a rocker in the keel and aids in the structural integrity of the kayak. A plurality of fasteners on the exterior side of the starboard hull side accommodate a second strap, wherein the second strap pulls the second V-shaped center crease closed upon itself, pinching the starboard hull side on itself to create a rocker in the keel and aiding structural integrity of the kayak.

In one embodiment of the invention, the foldable hull comprises a single sheet of plastic. This sheet of plastic is comprised of polypropylene twinwall plastic sheet in a preferred embodiment.

To form a water-tight forward stem seal and foldable hinge, the keel, proximate the bow of the kayak, is heat sealed. To form a water-tight forward stem seal and foldable hinge, the keel, proximate the stern of the kayak, is heat sealed.

A center crease traverses the long axis of the plastic sheet, and the center crease forms the kayak keel when folded. The plastic sheet comprises a plurality of chine creases that are mirrored on each side of the center crease. The chine creases form the multichine hull sides when folded. The chines creases allow a somewhat smooth hull curvature and prevent accidental and unwanted creasing of the hull material. A bow crease perpendicular to the center crease that is situated between the bow edge of the plastic sheet and the center of the plastic sheet is used to fold the kayak upon itself. A stern crease perpendicular to the center crease is situated between the stern edge of the plastic sheet and the center of the plastic sheet, and is also used to fold the kayak upon itself.

A plurality of first angled cuts emanate from a forward point on the keel, the first angled cuts having a size and dimension to remove material from the plastic sheet and defining the edges that fold into the forward stem. A plurality of second angled cuts emanate from an aft point on the keel, the second angled cuts having a size and dimension to remove material from the plastic sheet defining the edges that fold into the aft stem.

The invention also contemplates a method of unfolding a foldable kayak comprising the steps of unclipping a strap that maintains the kayak in a folded state; unfolding the forward end of the kayak along a forward crease; unfolding the aft end of the kayak along a stern crease; and spreading open the cockpit of the kayak. In one embodiment, the method further comprises the step of tightening straps to maintain the kayak in an unfolded state. One embodiment includes the step of inserting a floor panel into the cockpit aperture. The floor panel comprises a seat.

The invention also contemplates a method of sealing the seams of a kayak made from polypropylene twinwall plastic sheet comprising the steps of: creasing a first sheet having a first side and a second side with a die creating a first crease and first indentation on the first side; creasing a second sheet having a first side and a second side with a die creating a second crease and second indentation on the first side; orienting the first indentation of the first side of the first sheet opposite the second indentation of the first side of the second sheet forming a small substantially symmetrical inter-sheet cavity; clamping against the second side of the first sheet and the second side of the second sheet along the crease lines, creating a crease junction, and causing the inter-sheet cavity to collapse and the sheets to flare outwardly and opposedly deflect; heating the crease junction between the sheets, on the first sides of both sheets, from the direction where the sheets outwardly flare and opposedly deflect, also heating the first side of the first sheet proximate the first crease and the first side of the second sheet proximate the second crease; clamping the heated sheets using a substantially flat clamping surface; and fusing the heated sheets together forming a water-tight junction and hinged seam.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a schematic illustration of an isometric view of one embodiment of the invention;

FIG. 2 is a schematic illustration of a top view of one embodiment of the invention;

FIG. 3 is a schematic illustration of a top view of one embodiment of the invention;

FIG. 4 is a schematic illustration of a side view of one embodiment of the invention;

FIG. 5 is a schematic illustration of an isometric view of one embodiment of the invention;

FIG. 6 is a schematic illustration of an isometric view of one embodiment of the invention;

FIG. 7 is a schematic illustration of an isometric view of one embodiment of the invention;

FIG. 8 is a schematic illustration of an isometric view of one embodiment of the invention;

FIG. 9 is a schematic of one embodiment of a side view illustrating the method of the invention;

FIG. 10 is a schematic of one embodiment of a side view illustrating the method of the invention;

FIG. 11 is a schematic of one embodiment of a side view illustrating the method of the invention;

FIG. 12 is a schematic of one embodiment of a side view illustrating the method of the invention;

FIG. 13 is a schematic of one embodiment of a side view illustrating the method of the invention; and

FIG. 14 is a schematic of one embodiment of a side view illustrating the method of the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

### Collapsible Boat Hull

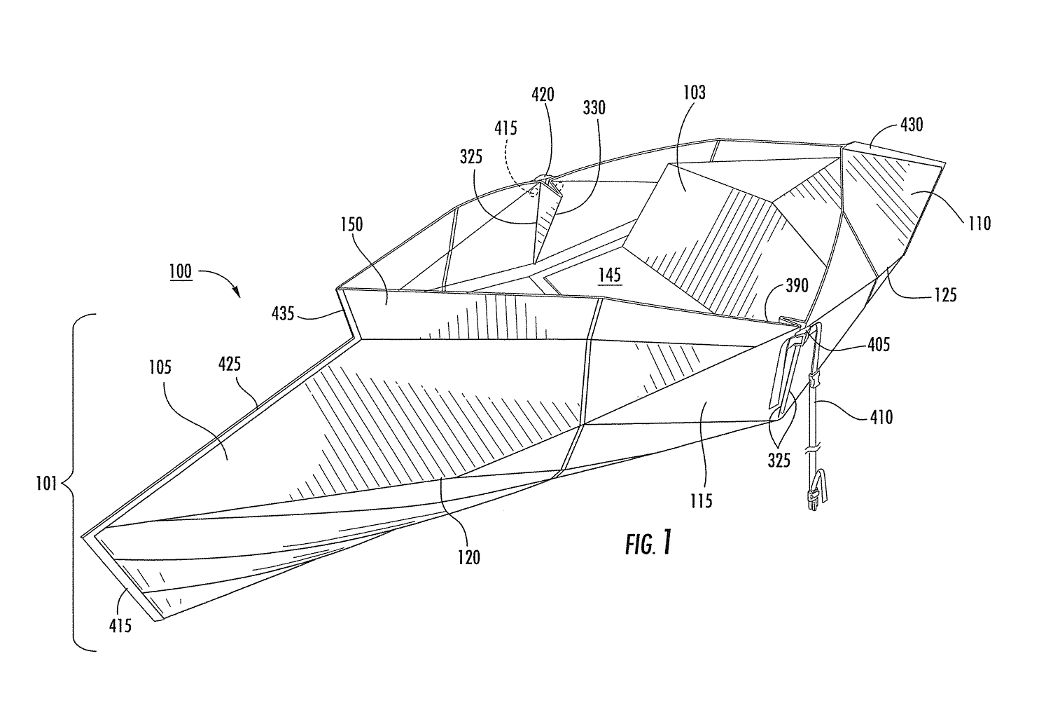

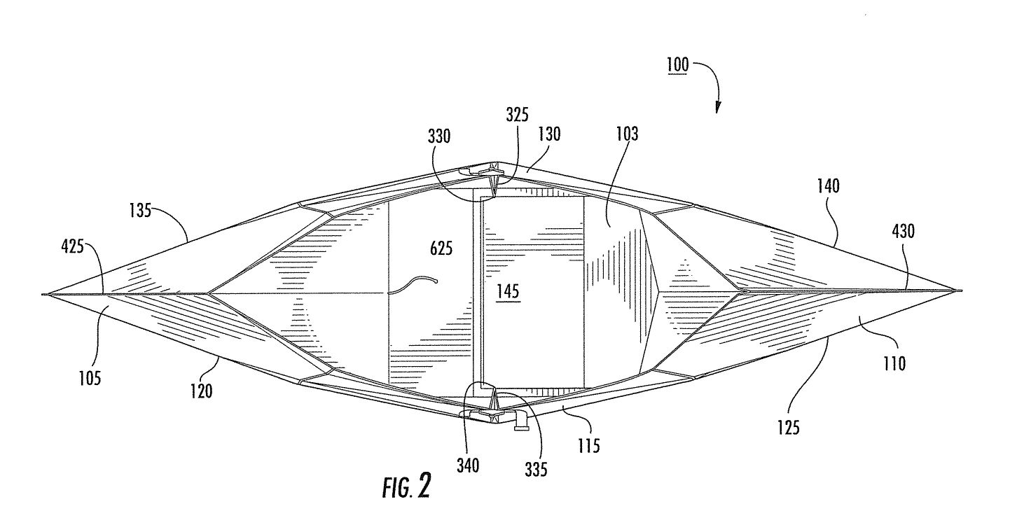

The present invention is generally directed to a collapsible boat hull. In a preferred embodiment, the boat is a kayak, and is made from lightweight materials to promote ease of storage, transportation, and use. Referring initially to FIG. 1, an illustrative embodiment of the kayak 100 is shown in the fully open conformation. In this embodiment, the kayak is made of two sheets of material, the first sheet of material substantially forming the hull 101 of the kayak, and the second sheet substantially forming a hull insert 103. In this conformation, the kayak 100 comprises the basic features of a standard kayak, including a forward deck 105 and aft deck 110. A port hull side 115 of the kayak 100 meets the port side edge of the forward deck 105 to define the forward port side gunwale 120. The port hull side 115 of the kayak 100 meets the port side edge of the aft deck 110 to define the aft port side gunwale 125. A starboard hull side 130, as is visible in the illustration of FIG. 2, of the kayak 100 meets the starboard side edge of the forward deck 105 to define the forward starboard side gunwale 135. The starboard hull side 130 of the kayak 100 meets the starboard side edge of the aft deck 110 to define the aft starboard side gunwale 140. The gunwales 120, 125, 135, 140 are formed from creases in the first sheet of material, maintaining a watertight fold.

### Crease and Cut Layout and Geometry

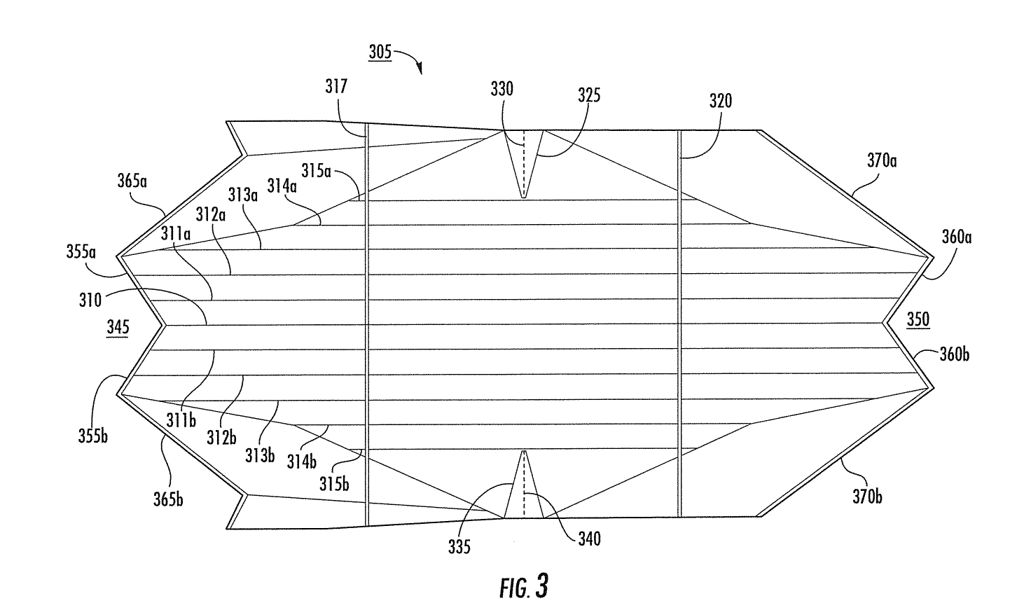

FIG. 3 illustrates one embodiment of the first sheet of material 305. The first sheet 305 is made of plastic. In one embodiment, the first sheet 305 is made of a corrugated plastic. In a preferred embodiment, the first sheet 305 is made of polypropylene twinwall plastic sheet. In one embodiment, the first sheet 305 is approximately 84 inches long by approximately 48 inches wide. The first sheet 305 comprises a number of creases that define the lines wherein the hull will bend. In the open conformation, the kayak 100 comprises a plurality of folds that are each one of acute, obtuse, and straight.

A center crease 310 traverses the long axis of the first sheet 305, and defines the keel in the open conformation of the kayak 100. A plurality of mirrored chine creases 311a, 311b, 312a, 312b, 313a, 313b, 314a, 314b, 315a, 315b are substantially parallel to the center crease 310. The number of chine creases is at least two chine creases per hull side to 20 chine creases per hull side. In a preferred embodiment, there are five chine creases per hull side, and each chine crease is equidistantly spaced in relation to adjacent chine creases. In a preferred embodiment, the starboard side chine creases 311a, 312a, 313a, 314a, 315a are spaced roughly three inches from each other and the port side chine creases are spaced roughly three inches from each other. In the open conformation of the kayak 100, each starboard side chine crease 311a, 312a, 313a, 314a, 315a is bent at an angle to define the multichine hull of the starboard hull side 130 and each port side chine crease 311b, 312b, 313b, 314b, 315b is bent at an angle to define the multichine hull of the port hull side 115.

Approximately 30 inches from the bow is a bow crease 317 situated perpendicularly to the center crease 310, the bow crease traversing the width of the first sheet 305. The bow crease 317 provides a folding point for the kayak 100 to fold upon itself when in the folded conformation. Approximately 30 inches from the stern is a stern crease 320 situated perpendicularly to the center crease 310, the stern crease traversing the width of the first sheet 305. The stern crease 320 provides a folding point for the kayak 100 to fold upon itself when in the folded conformation.

On approximately the midline of the kayak 100 that is perpendicular to the center crease 310, a starboard side V-crease 325 extending medially from the starboard hull side of the first sheet 305 to meet at the point of the “V.” A first bisecting crease 330 splits the starboard side V-crease 325 extending medially from the starboard hull side of the first sheet 305 to meet at the point of the “V.” A port side V-crease 335 extending medially from the port hull side of the first sheet 305 to meet at the point of the “V.” A second bisecting crease 340 splits the port side V-crease 325 extending medially from the port hull side of the first sheet 305 to meet at the point of the “V.” The side V-creases 325, 335 fold inwardly from the exterior sides 115, 130 of the kayak 100 when the kayak 100 is in the open conformation, pinching the exterior sides 115, 130 upon themselves to create a rocker in the keel (center crease 310), and to cause the kayak 100 to maintain an open conformation.

Again noting FIG. 3, a plurality of cuts is made in the first sheet 305 to impart a final kayak-like shape to the unfolded kayak 100. In particular, measuring from a construction line perpendicular to the center crease 310 that bisects the most distal forward point on the center crease, a first forward stem cut 355a is made in the first sheet 305 comprising an angle from 25° to 60° and a second forward stem cut 355b is made in the first sheet 305 comprising an angle from 120° to 155°. In a preferred embodiment, the angles are 36° and 144° respectively. This creates a forward wedge shaped area 345 wherein material is removed from the first sheet 305 at the bow of the kayak, the wedge having an angle between 60° and 130° with a preferred angle of 108°. The same angle constraints for the forward wedge area 345 are mirroredly applied to cuts made at the stern of the kayak 100 defining an aft wedge shaped area 350, a first aft stem cut 360a, and a second aft stem cut 360b. The edges of the first sheet 305 that are defined after removing the material of forward wedge area 345 are attached together (method described below) to form the forward stem 415 (FIG. 4). The edges of the first sheet 305 that are defined after removing the material of the aft wedge area 350 are attached together (method described below) to form the aft stem 420 (FIG. 4).

Still noting FIG. 3, additional cuts are made on the edges of the first sheet 305 to define the forward deck 105 and the aft deck 110 of the final unfolded kayak 100. In particular, measuring from a construction line perpendicular to the first cut in the first sheet 305 that bisects the most distal point of the first cut on the first sheet 305, a first forward deck cut 365a is made measuring from 0° to 20°, with a preferred angle of approximately 6°. Measuring from a construction line perpendicular to the second cut in the first sheet 305 that bisects the most distal point of the second cut on the first sheet 305, a second forward deck cut 365b is made measuring from 0° to 20°, with a preferred angle of approximately 6°. The same angle constraints for the forward deck cuts 365a, 365b are mirroredly applied to cuts made at the stern of the kayak 100 defining a first aft deck cut 370a, and a second aft deck cut 370b. The edges of the first sheet 305 that are defined after removing the material of the forward deck cuts 365a, 365b are attached together (method described below) to form the forward deck seal 425 (FIG. 4). The edges of the first sheet 305 that are defined after removing the material of the aft deck cuts 370a, 370b are attached together (method described below) to form the aft deck seal 425 (FIG. 4).

### The Unfolded Vessel

FIG. 4 illustrates a side view of one embodiment of the open conformation of the kayak 100. A plurality of port fasteners 405 is attached to the port hull side 115. A port side strap 410 engages the port side fasteners 405. When the port side strap 410 is cinched tight, the port side V-crease 335 is securedly pinched upon itself. A plurality of starboard fasteners 415 is attached to the starboard hull side 130. A starboard side strap 420 engages the starboard side fasteners 415. When the starboard side strap 420 is cinched tight, the starboard side V-crease 325 is securedly pinched upon itself. The straps 410, 420 are made of at least one of rope, webbing, cloth, plastic, nylon, polypropylene, cotton, rubber, bungee shock cord, and any other material known in the art. The fasteners 405, 415 are at least one of slide releases, cam buckles, loops, hooks, D-rings, ratchets, footman loops, double bar buckles, carabineers, cleats and any other fastener known in the art. The fasteners 405, 415 are made from plastic, nylon, metal, fabric, and any other material known in the art.

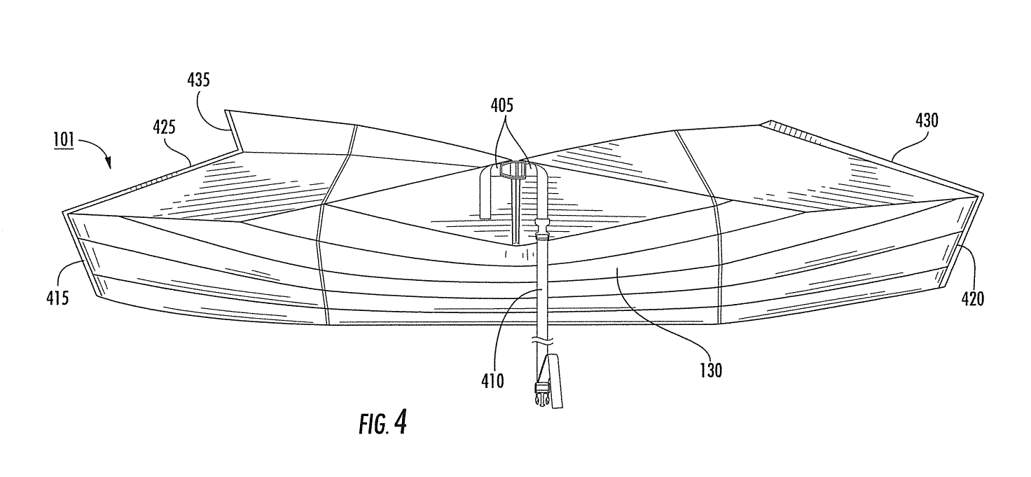

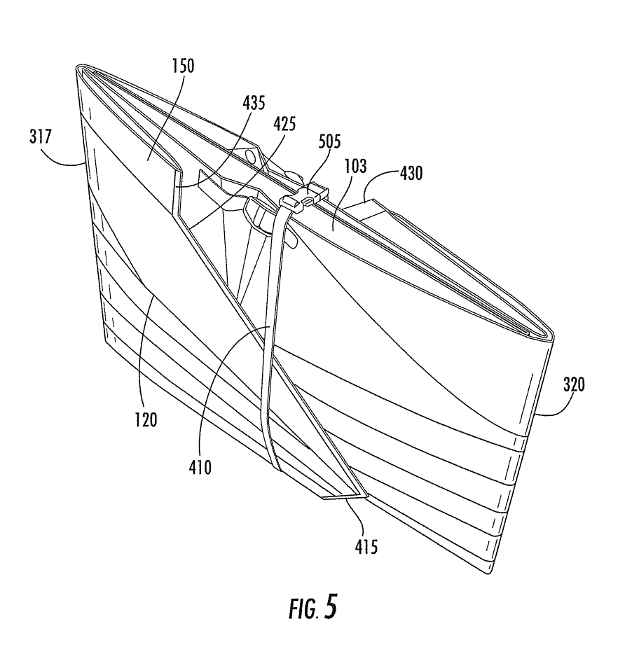

As FIG. 5 illustrates, in one embodiment, at least one strap 410, 420 is long enough to circumscribe the kayak 100. A storage fastener 505 engages at least one strap 410, 420 so that when the kayak 100 is in the folded conformation, the circumscribing strap 410, 420 keeps the kayak 100 in a compact and folded state. The storage fastener 505 is at least one of a slide release, cam buckle, loop, hook, D-ring, ratchet, footman loop, double bar buckle, carabineer, cleat and any other fastener known in the art. It should be noted that the insert 103 folds upon itself and fits inside the folded cockpit 145 of the folded kayak 100 for storage and transport.

In the open conformation a cavity is created on the interior surface of the kayak 100 that defines the cockpit 145. The cockpit 145 is where the operator of the kayak 100 sits. In one embodiment, the forward border of the cockpit 145 comprises a coaming 150. The second sheet of material is formed into an insert 103 having a size and dimension to securedly fit within the cockpit 145. The insert 103 bolsters the integrity of the kayak 100, adding a second layer of material as the floor 605 of the kayak 100 and by defining a transverse floor thwart member bolstering the integrity of the kayak 100, and serving as a platform to distribute a pilot's weight. Forward folds 610 in the insert 103 aid to conform the insert 103 to the shape of the kayak 100 floor. In one embodiment, a second panel of material 615 is attached to the insert 103, the second panel 615 having an appropriate size and dimension to fold into a seatback 620. To aid in removing the insert 103 from the cockpit 145, a pull tab 625 extends from proximate a central crease 630 in the panel 103. In one embodiment, an aft bulkhead panel 635 extends from second panel 615. In one embodiment, the aft bulkhead panel 635 is an extension of the seatback 620.

### Method of Unfolding and Folding the Kayak

Referring to FIG. 7, the method of unfolding the kayak 100 comprises a plurality of steps. In particular, any straps that are secured to hold the kayak 100 in a folded conformation are released. The bow crease 317 and the stern crease 320 are unfolded. The bow and stern of the kayak are extended until the bow crease 317 and the stern crease 320 form substantially 180° angles. The coaming 150 is spread apart to open the cockpit 145. If no coaming is present on the embodiment of the kayak 100, the opening in the hull that defines the cockpit 145 is spread apart to open the cockpit 145. The starboard side strap 420 is tightly cinched to pinch the starboard side V-crease 325 upon itself. The port side strap 410 is tightly cinched to pinch the port side V-crease 335 upon itself. The insert 103 is placed in the cockpit with the seatback 620 towards the aft of the kayak 100. The insert 103 must be bent at the central crease 630 to fit in the opening of the cockpit 145 and then the insert is extended so that the central crease 630 has an approximate angle of 180°. The kayak 100 is then introduced into a body of water and the user enters and is seated in the cockpit 145. To remove the insert, a user, from without the kayak 100, pulls the pull tab 625, causing the central crease 630 to bend so the insert 103 disengages from the cockpit 145. The starboard side strap 420 is released from tension so the starboard side V-crease 325 relaxes. The port side strap 410 is released so the port side V-crease 335 relaxes. The kayak 100 is folded along the center crease 310 causing the chine creases 311a, 312a, 313a, 314a, 315a, 311b, 312b, 313b, 314b, 315b to relax and the kayak 100 to maintain a relatively flat conformation. The cockpit 145 forms a pocket in this conformation, and can store the folded insert 103. The bow crease 317 is folded so that the bow section 705 points aft. The stern crease 320 is folded so that the stern section 710 points forward. A strap 410, 420 is made to circumscribe the kayak and then fastened, capturing the bow section 705 and the stern section 710 against the sides of the kayak 100 as illustrated in FIG. 5.

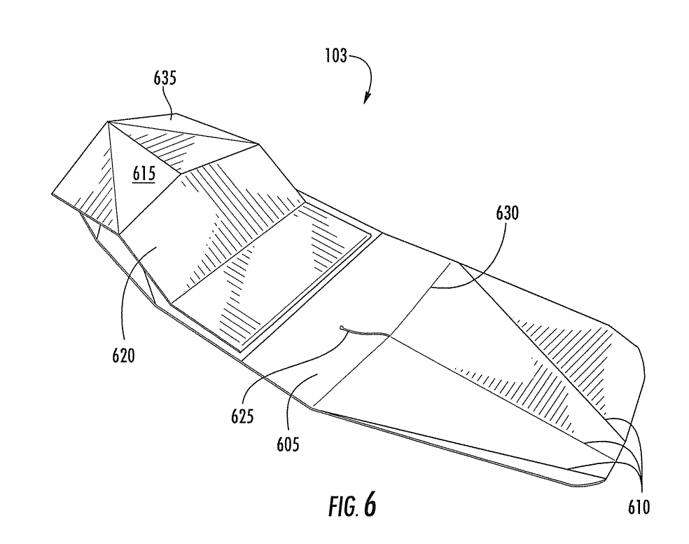

Noting FIG. 8, to form the sealed edges of the forward stem seal 415, the aft stem seal 420, the forward deck seal 425, the aft deck seal 430, and the coaming seal 430 are water-tight, yet hingedly flexible junctions 800.

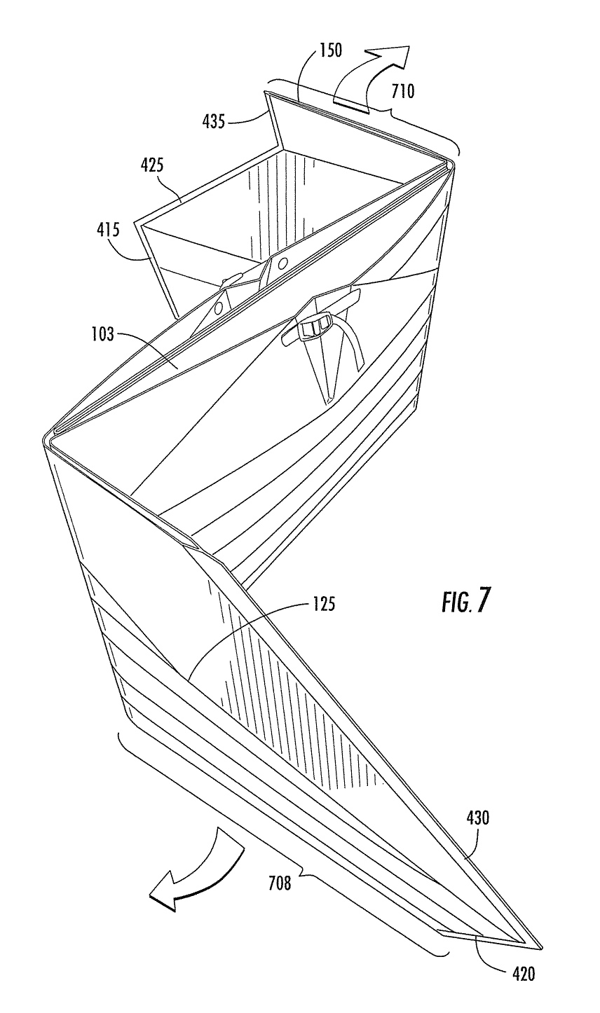

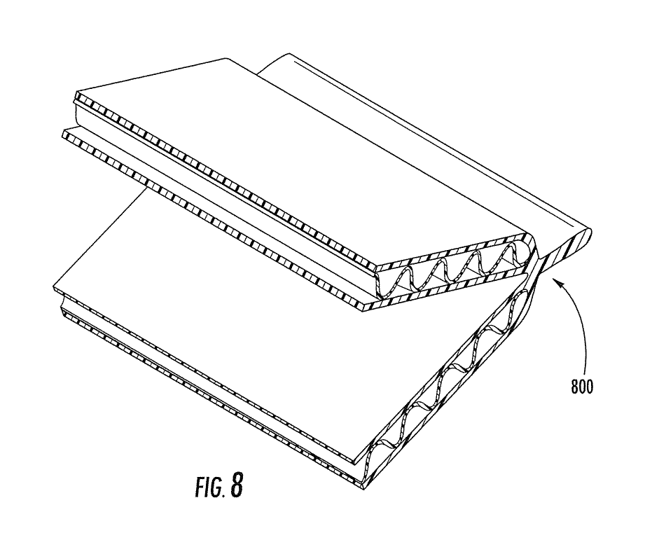

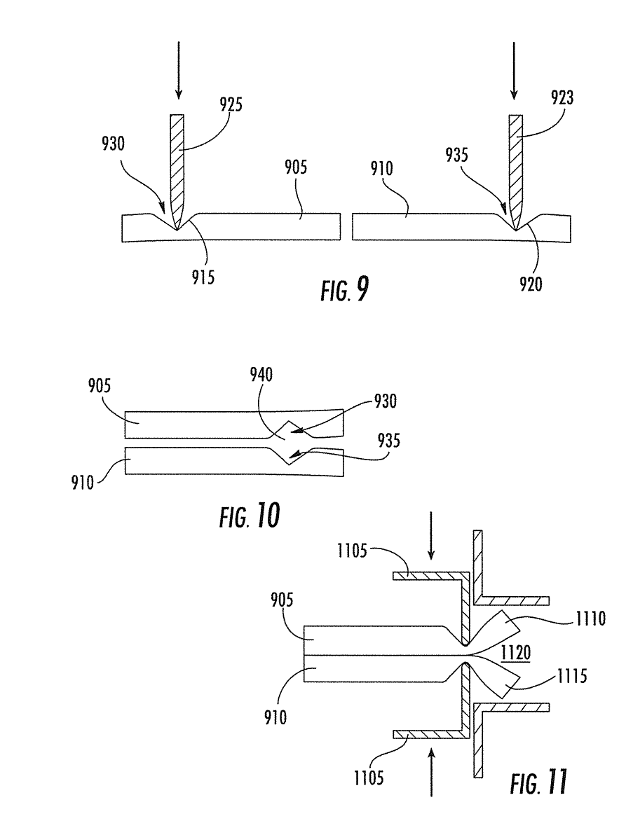

The method to seal the seams of polypropylene twinwall plastic sheet are illustrated by FIGS. 9-14.

### Method of Constructing Sealed Seams of the Kayak

FIG. 9 illustrates the creasing of a first polypropylene twinwall plastic sheet 905 and a second polypropylene twinwall plastic sheet 910. In one embodiment, a crease 915, 920 is formed when a pointed die 925 is pressed onto the plastic sheets 905, 910. The creasing of the plastic sheets 905, 910 results in indentations 930, 935 that remain in the plastic sheets 905, 910 after the die 925 is removed.

FIG. 10 illustrates orienting the first sheet 905 and the second sheet 910 so that the indentations 930, 935 are mirroredly adjacent to form an inter-sheet cavity 940 that is substantially defined by the profiles of the indentations 930, 935.

FIG. 11 illustrates the clamping of a first clamp 1105 against the mirroredly adjacent plastic sheets 905, 910 along the creases 915, 920. The first clamp 1105 is of a size and dimension so that upon exerting clamping pressure by the first clamp 1105 along the creases 915, 920, the inter-sheet cavity 940 collapses causing a first end 1110 of the first sheet 905 to outwardly deflect in a direction opposing a second end 1115 of the second sheet 910. The outward deflection of the sheet ends 1110, 1115 defines a crease junction 1120.

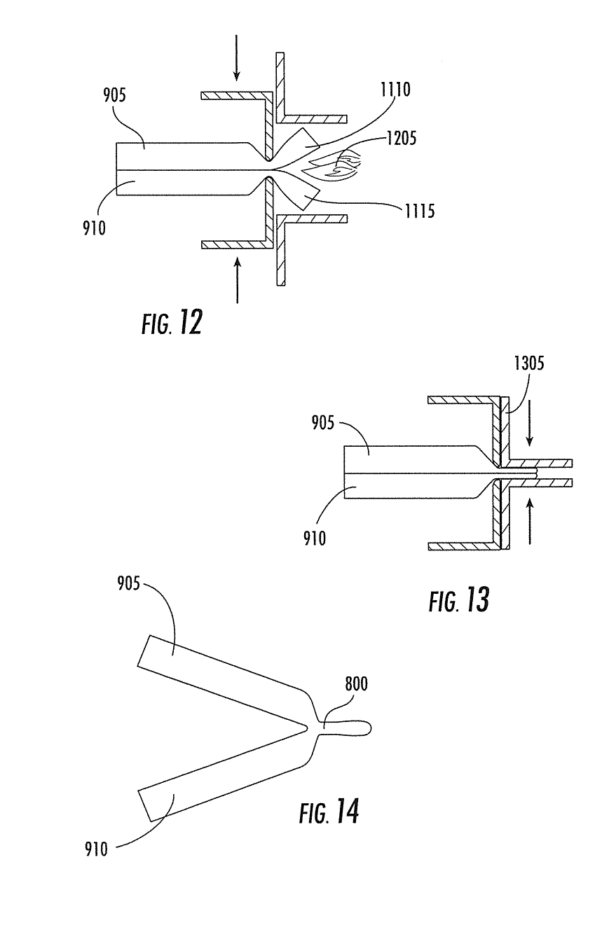

FIG. 12 illustrates heating of the crease junction 1120 using a heat source 1205. The heat source 1205 is at least one of a flame, heated air, heating element, combinations thereof, and any other heat source known in the art. The heat source melts the plastic surfaces of the crease junction 1120. FIG. 13 and FIG. 14 illustrate the step wherein a second clamp 1305 applies clamping pressure to the first end 1110 and the second end 1115 of the sheets. The second clamp 1305 is adjacent to the first clamp 1105. The second clamp 1305 comprises a substantially flat clamping surface having a size and dimension to clamp the melted sheet ends 1110, 1115 together. When the second clamp 1305 clamps its jaws together, clamping the heated first end 1110 and the heated second end 1115 of the sheets together, the sheets are melted together, creating a water-tight hingedly flexible junction 800 as shown in FIG. 14 and FIG. 8.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A foldable kayak comprising:
a foldable multichine hull comprising a cockpit of a size and dimension to fit a pilot;
a forward top deck extending from the cockpit to a bow of the kayak;
an aft top deck extending from the cockpit to a stern of the kayak;
a port hull side that extends from the bow of the kayak to the stern of the kayak comprising multiple chines, the chines extending from proximate the bow of the kayak to proximate the stern of the kayak, wherein the port hull side meets the forward and aft top decks defining a port side gunwale; and
a starboard hull side that extends from the bow of the kayak to the stern of the kayak comprising multiple chines, the chines extending from proximate the bow of the kayak to proximate the stern of the kayak, wherein the starboard hull side adjoins the forward and aft top decks defining a starboard side gunwale, wherein the port hull side and the starboard hull side meet underside the kayak to define a keel that runs from the bow of the kayak to the stern of the kayak.

2. The invention of claim 1 further comprising:
a foldable insert of a size and dimension to fit inside the cockpit, comprising a floor thwart that runs from proximate the bow of the kayak to proximate the stern of the kayak that substantially defines a kayak floor;
a seat bottom defined by a second panel fixedly attached to the foldable insert, the second panel comprising a hinged flap that defines a seat back; and
a second multi-crease flap of the second panel hingedly extending from the first flap, the second flap that engages at least one interior wall of the cockpit defining an aft bulkhead.

3. The invention of claim 1 further comprising a cockpit coaming that extends from the aft deck proximate a border where the aft deck meets the cockpit.

4. The invention of claim 1, further comprising:
a first V-shaped center crease on the port hull side having a first bisecting crease beginning at the apex of the first V-shaped center crease and ending at the port side gunwale;
a plurality of fasteners on the exterior side of the port hull side that accommodate a first strap, wherein the first strap pulls the first V-shaped center crease closed upon itself, pinching the port hull side on itself to create a rocker in the keel and aiding in the structural integrity of the kayak;
a second V-shaped center crease on the starboard hull side having a second bisecting crease beginning at the apex of the second V-shaped center crease and ending at the starboard side gunwale; and
a plurality of fasteners on the exterior side of the starboard hull side that accommodate a second strap, wherein the second strap pulls the second V-shaped center crease closed upon itself, pinching the starboard hull side on itself to create a rocker in the keel and aiding structural integrity of the kayak.

5. The invention of claim 1, wherein the foldable hull comprises a single sheet of plastic.

6. The invention of claim 5, wherein the sheet of plastic is comprised of polypropylene twinwall plastic sheet.

7. The invention of claim 6, wherein:
the keel, proximate the bow of the kayak, is heat sealed forming a water-tight forward stem seal and foldable hinge; and
the keel, proximate the stern of the kayak, is heat sealed forming a water-tight aft stem seal and foldable hinge.

8. The invention of claim 6, comprising:
a center crease traversing the long axis of the plastic sheet, the center crease forming the kayak keel when folded;
a plurality of chine creases mirrored on each side of the center crease, the chine creases forming the multichine hull sides when folded;
a bow crease perpendicular to the center crease situated between the bow edge of the plastic sheet and the center of the plastic sheet, used to fold the kayak upon itself; and
a stern crease perpendicular to the center crease situated between the stern edge of the plastic sheet and the center of the plastic sheet, used to fold the kayak upon itself.

9. The invention of claim 8, wherein:
a plurality of first angled cuts emanate from a forward point on the keel, the first angled cuts having a size and dimension to remove material from the plastic sheet defining the edges that fold into the forward stem; and
a plurality of second angled cuts emanate from an aft point on the keel, the second angled cuts having a size and dimension to remove material from the plastic sheet defining the edges that fold into the aft stem.

10. The method of unfolding a foldable kayak comprising the steps of:
unclipping a strap that maintains the kayak in a folded state;
unfolding the forward end of the kayak along a forward crease;
unfolding the aft end of the kayak along a stern crease; and
spreading open the cockpit of the kayak.

11. The method of claim 10, further comprising the step of tightening straps to maintain the kayak in an unfolded state.

12. The method of claim 10, further comprising the step of inserting a foldable insert that defines a floor panel into a cockpit aperture.

13. The method of claim 12, wherein the foldable insert comprises a seat.

14. The method of sealing seams of a kayak made from polypropylene twinwall plastic sheet comprising the steps of:
(a) creasing a first sheet having a first side and a second side with a die creating a first crease and first indentation on the first side;
(b) creasing a second sheet having a first side and a second side with a die creating a second crease and second indentation on the first side;
(c) orienting the first indentation of the first side of the first sheet opposite the second indentation of the first side of the second sheet forming a small substantially symmetrical inter-sheet cavity;
(d) clamping against the second side of the first sheet and the second side second sheet along the crease lines, creating a crease junction, and causing the inter-sheet cavity to collapse and the sheets to flare outwardly and opposedly deflect;
(e) heating the crease junction between the sheets, on the first sides of both sheets, from the direction where the sheets outwardly flare and opposedly deflect, also heating the first side of the first sheet proximate the first crease and the first side of the second sheet proximate the second crease;
(f) clamping the heated sheets using a substantially flat clamping surface; and
(g) fusing the heated sheets together forming a water-tight junction and hinged seam.
